(19) United States
(12) Patent Application Publication
(10) Pub. No.: US 2018/0041244 A1
(43) Pub. Date: Feb. 8, 2018

(54) RF FRONT END RESONANT MATCHING CIRCUIT

(71) Applicant: QUALCOMM Incorporated, San Diego, CA (US)

(72) Inventors: Yongwang DING, Dublin, CA (US); Feipeng WANG, San Jose, CA (US); Ji-Hoon PARK, Sunnyvale, CA (US); Pingli HUANG, Cupertino, CA (US); Yido KOO, Belmont, CA (US)

(21) Appl. No.: 15/444,057

(22) Filed: Feb. 27, 2017

Related U.S. Application Data
(60) Provisional application No. 62/371,611, filed on Aug. 5, 2016.

(51) Int. Cl. H04B 1/48

(52) U.S. Cl. CPC H04B 1/48

(57) ABSTRACT

The disclosure provides a device for impedance matching and switching for coupling a transmit path and a receive path of a transceiver to at least one antenna. The device can have an on-chip matching circuitry disposed within a chip and off-chip matching circuitry disposed outside the chip but coupled to the on-chip matching circuitry. The device can have a controller coupled to the on-chip matching circuitry configured to switch the on-chip matching circuitry to provide matched impedance for the transmit path in a transmit mode and matched impedance for the receive path in a receive mode. The off-chip matching circuitry can provide high impedance in the receive path in the transmit mode and provide high impedance in the transmit path in the receive mode. The resonant matching circuit can also have an antenna node coupling the transmit path and the receive path to the at least one antenna.

### CROSS REFERENCE TO RELATED APPLICATIONS

This application claims benefit to U.S. Provisional Application 62/371,611, entitled “RF FRONT END RESONANT MATCHING CIRCUIT,” filed on Aug. 5, 2016, the entirety of which is hereby incorporated by reference herein.

### BACKGROUND

### Technical Field

This disclosure relates generally to a radio-frequency (RF) front end circuit. More specifically, this disclosure relates to an RF front end resonant matching circuit.

### Related Art

In a time division duplex (TDD) system, such as in a wireless local area network (WLAN) application, transmitter (Tx) and receiver (Rx) can be alternately turned on to transmit and receive the wireless signals. To share the same antenna for low cost applications, the Tx and the Rx are connected together through a transmit/receive (TR) switch circuit (TRSW) to provide the necessary isolation between the Tx and the Rx.

In some examples, the off-chip TRSW can be a single-pole double-throw (SPDT) switch. When the Tx is on, the TRSW is switched on at the Tx path and off at the Rx path. When the Rx is on, the TRSW is switched on at the Rx path and off at the Tx path. However, the off-chip TRSW can add to the bill of materials (BOM) cost and increases the system complexity, such as a need to provide an external control signal to the TRSW from the chip. It would be beneficial to eliminate the need for an off-chip TRSW to save on circuit cost and complexity.

### SUMMARY

This disclosure is directed to circuitry for use in impedance matching and antenna switching for one or more radio frequency (RF) amplifiers. The use of the circuits and concepts disclosed herein provide antenna switching between one or more transmit paths and receive paths while providing impedance matching between the RF amplifiers and one or more antennas.

An aspect of the disclosure provides a resonant matching circuit being at least partially disposed on a chip. The resonant matching circuit can have a transmitter off-chip matching circuit disposed outside the chip and coupled to an antenna node. The resonant matching circuit can have a transmitter on-chip matching circuit disposed within the chip and coupled to the transmitter off-chip matching circuit. The transmitter on-chip matching circuit can have a transistor and a first capacitor coupled between a first output and a second output of a power amplifier. The resonant matching circuit can have a receiver off-chip matching circuit coupled to the antenna node. The resonant matching circuit can have a receiver on-chip matching circuit disposed within the chip and coupled to the receiver off-chip matching circuit. The receiver on-chip matching circuit can have a first switch connected between a first input of a low noise amplifier and ground, and a second switch connected between a second input of the low noise amplifier and ground.

Another aspect of the disclosure provides a resonant matching circuit coupling a transmit path and a receive path of a transceiver to at least one antenna. The resonant matching circuit can have off-chip matching circuitry disposed outside a chip. The off-chip matching circuitry can have a first transmit path matching circuitry and first receive path matching circuitry. The resonant matching circuit can have on-chip matching circuitry disposed within the chip and coupled to the off-chip circuitry and having a second transmit path matching circuitry and a second receive path matching circuitry. The on-chip matching circuitry in combination with the off-chip matching circuity can, in a transmit mode of the resonant matching circuit, selectively activate a plurality of switches of the on-chip matching circuitry to provide a matched impedance in the transmit path including the first and second transmit path matching circuitry and provide a high impedance in a receive path including the first and second receive path matching circuitry. The on-chip matching circuitry in combination with the off-chip matching circuity can, in a receive mode of the resonant matching circuit, selectively activate the plurality of switches of the on-chip matching circuitry to provide a matched impedance in the receive path, and provide a high impedance in the transmit path.

Another aspect of the disclosure provides an apparatus for matching impedance in a circuit having a transmit path and a receive path coupling a transceiver to at least one antenna. The apparatus is at least partially deployed on a chip. The apparatus can have a first means for impedance matching for matching impedance between the transceiver and the at least one antenna. The first means for impedance matching can be disposed within the chip. The apparatus can have a means for controlling the first means for impedance matching. The means for controlling can cause the first means for impedance matching to provide a matched impedance in the transmit path in a transmit mode. The means for controlling can cause the first means for impedance matching to provide a matched impedance in the receive path in a receive mode. The apparatus can have a second means for impedance matching for providing high impedance in the receive path in the transmit mode and providing high impedance in the transmit path in the receive mode. The second means for impedance matching can be disposed outside the chip and coupled to the first means for impedance matching. The apparatus can have a means for coupling the transmit path and the receive path to the at least one antenna.

Another aspect of the disclosure provides a resonant matching circuit for matching impedance in a circuit having a transmit path and a receive path coupling a transceiver to at least one antenna, the resonant matching circuit being at least partially deployed on an integrated circuit (IC). The resonant matching circuit can have on-chip matching circuitry disposed within the IC and coupled to at least first and second radio frequency (RF) amplifiers. The on-chip matching circuitry can have a transmitter on-chip matching circuit in the transmit path. The on-chip matching circuitry can have a receiver on-chip isolation circuit in the receive path. The resonant matching circuit can have off-chip matching circuitry disposed outside the IC and coupling the on-chip matching circuitry to an antenna node for coupling to the at least one antenna. The off-chip matching circuitry can have a transmitter off-chip matching circuit in the transmit path. The off-chip matching circuitry can have a receiver off-chip matching circuit in the receive path. The resonant matching circuit can have a controller coupled to the on-chip matching circuitry. The controller can activate the transmitter on-chip matching circuit to provide, in combination with the transmitter off-chip matching circuitry, matching between the first RF amplifier and the antenna node in a transmit mode. The controller can deactivate the receiver on-chip isolation circuit to provide in combination with the receiver off-chip matching circuitry, matching between the second RF amplifier and the antenna node in a receive mode.

Other features and advantages of the present disclosure should be apparent from the following description which illustrates, by way of example, aspects of the disclosure.

### BRIEF DESCRIPTION OF THE DRAWINGS

The following is a brief description of the accompanying drawings, wherein like numbers refer to like features and characteristics throughout the following Detailed Description, and wherein:

FIG. 1 is a circuit diagram of an embodiment of a direct internal transmit-receive switch;

FIG. 2 is a functional block diagram of a front-end circuit having an on-chip matching circuit and an off-chip matching circuit; and

FIG. 3 is a circuit diagram of an embodiment of the RF front-end circuit of FIG. 2.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that the disclosure may be practiced without these specific details.

In some instances, well-known structures and components are shown in simplified form for brevity of description. In certain implementations of the present disclosure, an RF front-end circuit incorporating resonant matching and/or impedance transformation is described. In one implementation, the resonant matching and/or impedance transformation is incorporated into both “on-chip” and “off-chip” configurations. Both on-chip and off-chip configurations may reside on a single printed circuit board (PCB). Thus, in some implementations, the mixture of the resonant matching and/or impedance transformation performed on-chip and off-chip provides more flexibility and higher performance than either the external TRSW implementation or the on-chip TRSW implementation alone. In another implementation, the resonant matching and/or impedance transformation may be accomplished on-chip only.

After reading this description it will become apparent how to implement the disclosure in various implementations and applications. As used herein, the term “on-chip” may refer to circuitry that can be designed and fabricated on a chip, for example, silicon or other semi-conducting materials (e.g., wafers). Such “on-chip” circuitry can be synonymous with an integrated circuit (“IC”). “Off-chip” circuitry, on the other hand, may be part of the same overall system or larger circuit within a printed circuit board (PCB); however it is necessarily not on the IC with the “on-chip” circuitry. In some implementations, the “off-chip” circuitry may be located on a different chip than the chip with the “on-chip” circuitry.

Although various implementations of the present disclosure will be described herein, it is understood that these implementations are presented by way of example only, and not limitation. As such, this detailed description of various implementations should not be construed to limit the scope or breadth of the present disclosure.

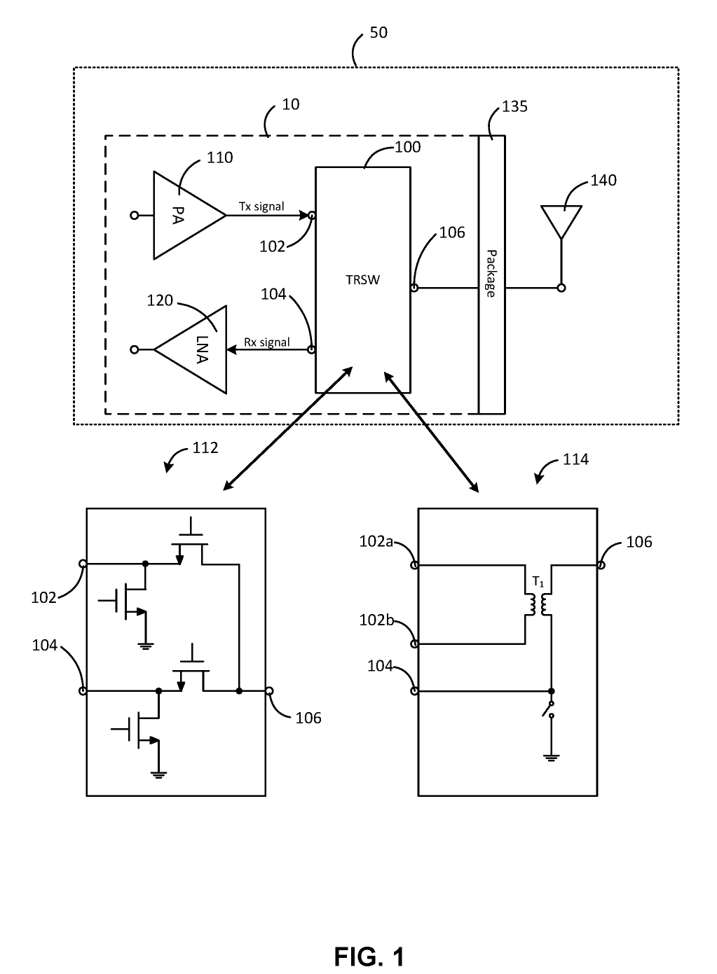

FIG. 1 is a circuit diagram of an embodiment of a direct internal transmit-receive switch. A chip 10 can be an integrated circuit (IC) or other self-contained microchip, silicon chip, or computer chip, etc. The chip 10 can be disposed on a PCB 50.

The chip 10 can have a TRSW 100. The TRSW can have a first input 102 from a power amplifier (PA) 110 that can receive a transmit (Tx) signal. The TRSW 100 can also have a second input 104 to a low noise amplifier (LNA) 120. The second input 104 can also be termed an output to the LNA 120 a receive (Rx) signal flows from the TRSW 100 to the LNA 120.

The TRSW 100 can also have an antenna coupling 106 coupled to an antenna 140. The antenna 140 is shown as a single antenna but can be implemented as one or more antennas. The antenna 140 can be disposed on the PCB 50, but is not required to be. The TRSW 100 can switchably couple the PA 110 and the LNA 120 to the antenna 140. The antenna 140 can transmit signals provided by the PA 110 and receive signals for the LNA 120.

The chip 10 can also have a package 135. As used herein, the package 135 can refer to the final encapsulating portion on the outer portion of the chip 10. The package 135 can be the case or outer shell of the chip 10 that contains semiconducting material that comprises an integrated circuit or the chip 10. The package 135 can further have various connectors, inputs, or outputs that allow connection of the inner components of the chip 10 (e.g., the TRSW 100) to a larger circuit on, for example, the PCB 50. For example, the package 135 can refer to the outer shell of the chip 10 that protects, for example, the PA 110, the LNA 120, and the TRSW 100.

The TRSW 100 can be implemented in several ways that provide an on-chip solution for the TRSW circuitry. In one example, the TRSW 100 can be implemented as a switch circuit 112. The switch circuit 112 can have multiple active MOS devices to allow switching between the PA 110 and the LNA 120. This can allow both the PA 110 and the LNA 120 to transmit/receive over the same antenna 140. This is particularly useful in a TDD arrangement.

An exemplary advantage of this implementation of the switch circuit 112 is a reduction in total BOM savings by reducing the number of components. This can be accomplished by incorporating the TRSW 100 on the chip. This eliminates the need for a TRSW 100 external to the chip (e.g., off-chip). However, such advantages of the direct switch implementation of the switch circuit 112 may be limited by certain degradations in linearity, reliability, and isolation, as well as increased insertion loss. This may lead to an increased need for specific high cost technologies such as silicon-on-insulator (SOI) technology to meet the high performance requirement. Other drawbacks include the circuit complexity (e.g., a negative voltage generator circuit may be needed) and the large size of the on-chip switch that can occupy a large portion of the chip area.

The TRSW 100 can also be implemented as a switch circuit 114. The switch circuit 114 is a different on-chip TRSW implementation than using the switch circuit 112. The switch circuit 114 can have the second input 104 and the antenna coupling 106. The switch circuit 114 can also have multiple first inputs 102a, 102b. The first inputs 102a, 102b can couple for example, the PA 110 to a transformer (T1) within the TRSW 100 (e.g., the switch circuit 114).

An exemplary advantage of the switch circuit 114 is that the total BOM costs are reduced by eliminating the need to implement the TRSW 100 in an off-chip configuration. However, this implementation can be less flexible since the first inputs 102a, 102b (for the PA 110) and the second input 104 (for the LNA 120) are internal to the chip. Accordingly, there may be no external pin connections to the PA 110 (input) and the LNA 120 (output). As shown, in the switch circuit 114 and the share the same transformer/inductor as a series matching circuit. Thus, the tuning of the switch circuit 114 may not be improved by external matching. Another drawback of the implementation of the switch circuit 114 includes the high sensitivity to the performance of the PA 110 to the PCB component variations.

It should be appreciated, that the switch circuit 112 and the switch circuit 114 are two possible solutions for implementing an on-chip TRSW 100.

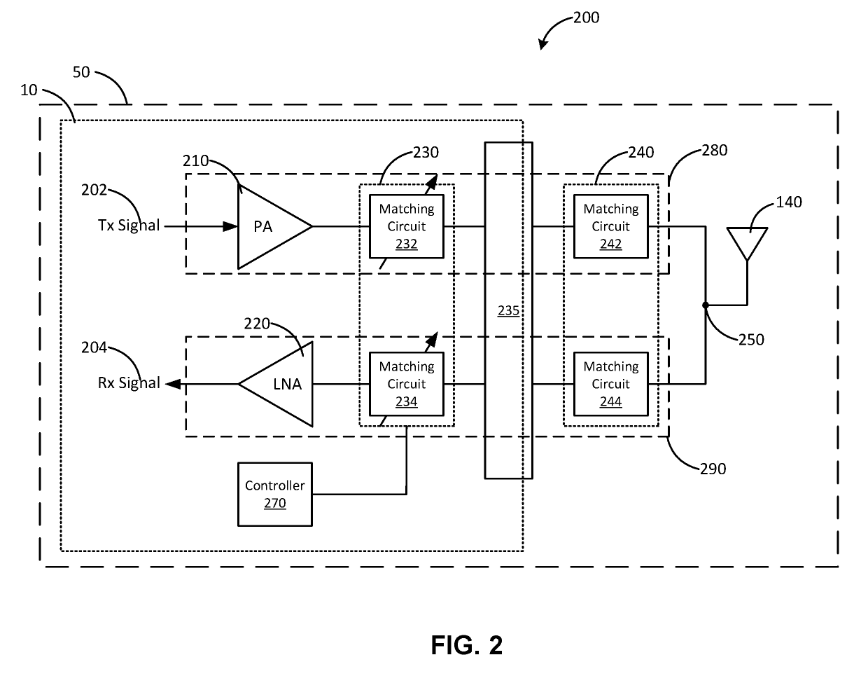

FIG. 2 is a functional block diagram of a front-end circuit having an on-chip matching circuit and an off-chip matching circuit. A front-end circuit (circuit) 200 can be disposed within a chip 10 that is located within a larger PCB 50, similar to FIG. 1. The chip 10 is represented by a dotted line, while the PCB 50 is represented by a dashed line. These representations are not drawn to scale and are provided for reference to indicate the relative boundaries of each component of the circuit 200.

The circuit 200 can have at least one transmit path (“transmit path” or “transmitter path”) 280 and at least one receive path (“receive path” or “receiver path”) 290. The transmit path 280 and the receive path 290 are indicated in dashed lines. The transmit path 280 and the receive path 290 can be joined together on the PCB 50, for example, at an antenna node 250. The antenna node 250 can be similar to the antenna coupling 106. The antenna node 250 can couple the transmit path 280 and the receive path 290 to the antenna 140. In some embodiments, the antenna node 250 can alternately couple the transmit path 280 and the receive path 290 to, for example, the antenna 140. The alternate coupling at the antenna node 250 can be caused by impedances provided by, for example, on-chip and off-chip impedance matching circuits, as described below. In some implementations, more than one transmit path 280 and more than one receive path 290 can be joined together at the antenna node 250.

The circuit 200 can have an RF block 210. The RF block 210 is shown as a PA (e.g., the PA 110). Thus, the RF block 210 may be referred to herein as the PA 210. The circuit 200 can also have an RF block 220. The RF block 220 is shown as a LNA (e.g., the LA 120). Thus, the RF block 220 may be referred to herein as the LNA 220. In an alternative implementation in which the receiver does not include an LNA, the RF block 220 can be configured as a mixer or other required RF element(s) in the receive path 290.

In some embodiments, the PA 210 and the LNA 220 may be located on the chip 10, for example and may therefore be referred to as “on-chip”. The antenna 140 and the antenna node 250 on the other hand, can be located on the PCB 50 on which the chip 10 resides. Thus, these components may be referred to as “off-chip.” The on-chip and off-chip portions of the circuit 200 can be coupled via a package 235. The package 235 can be similar to the package 135 (FIG. 1). Accordingly, the transmit path 280 and the receive path 290 can respectively couple the PA 210 and the LNA 220 to the antenna node 250 via the package 235.

The circuit 200 can have an on-chip matching circuitry 230. The on-chip matching circuitry 230 can have a transmitter on-chip matching circuit 232 (e.g., a transmit path matching circuit) and a receiver on-chip matching circuit 234 (e.g., a receive path matching circuit), for example in the respective transmit path 280 and receive path 290. The transmitter on-chip matching circuit 232 and the receiver on-chip matching circuit 234 can provide more flexibility and relaxed matching requirements on the off-chip matching. For example, the transmitter on-chip matching circuit 232 and the receiver on-chip matching circuit 234 can be controlled by internal or on-chip control signals (from e.g., a controller; see below) that can have separated matching impedance(s) in a receive mode and/or a transmit mode. This matching impedance can change depending on the operating mode and can tolerate larger variations or mismatches on the PCB loads.

The circuit 200 can also have an off-chip matching circuitry 240. The off-chip matching circuitry 240 can have a transmitter off-chip matching circuit 242 (e.g., a transmit path matching circuit) and a receiver off-chip matching circuit 244 (e.g., a receive path matching circuit). The transmitter off-chip matching circuit 242 and the receiver off-chip matching circuit 244 can be tuned for properties of different package products, for example. The on-chip matching circuitry 230 can be coupled to the off-chip matching circuitry 240 via the package 235 (e.g., via various pin connections). In some examples, the package 235 can have different electrical characteristics, such as parasitic self-inductance, parasitic self-capacitance, and parasitic mutual inductance and capacitance. These variations can be caused by different assembly processes, such as bonding and bumping, different materials, such as plastic compounds and ceramics. The characteristics can also vary in size, such as, for example, 10×10 mm² and 14×14 mm² Quad Flat No-lead (QFN) packages. Even with the same type and size package, different manufacturers can have different package electrical performance. The transmitter off-chip matching circuit 242 and the receiver off-chip matching circuit 244 can be adjusted or tuned accordingly to such differences.

The circuit 200 can also have a controller 270 coupled to at least the on-chip matching circuitry 230. The controller 270 can be one or more processors or microprocessors operable to configure the on-chip matching circuitry 230. In some embodiments the controller 270 can be a central processing unit (CPU) or a portion of a CPU.

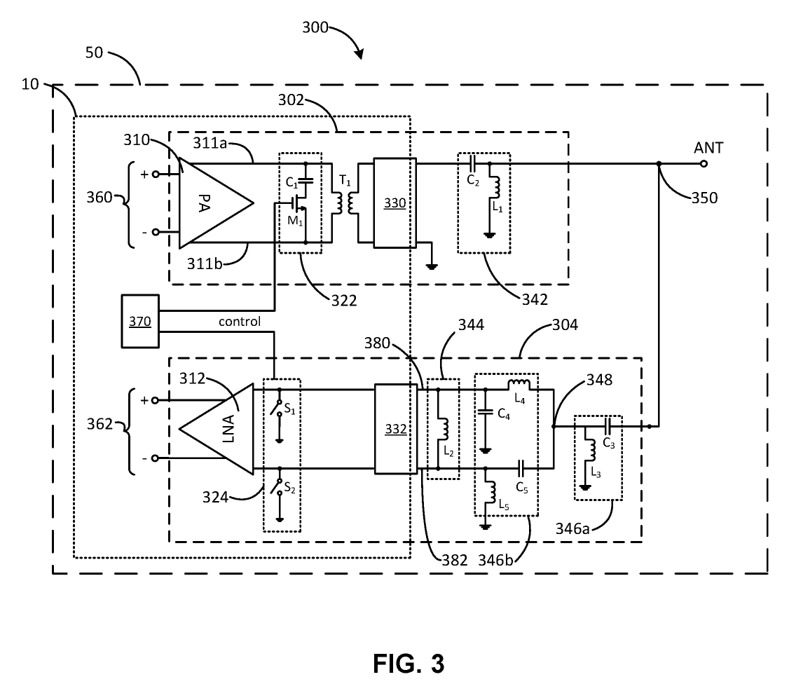

The transmitter on-chip matching circuit 232 can provide a predetermined range of “ON” impedances that can produce a high saturated output power (P_{SAT}) point for the PA 210. In some wireless applications, it may be preferred to have high P_{OUT}. To do so, the high P_{SAT} is required. For most PAs with constant supply voltage, the P_{SAT} is a function of the load impedance. For a given supply voltage and a given load impedance, the P_{SAT} is determined. The controller 270 can control the on-chip matching circuitry 230 to adjust the range of ON impedances based on the activation and deactivation of the circuit. In another example, internal components of the transmitter on-chip matching circuit 232 (such as, e.g., a capacitance, such as that labeled C1 in FIG. 3) can be programmable and used to tune the impedance.

The circuit 200 can have a transmit mode and a receive mode. In some embodiments, the receive path 290 may be deactivated (e.g., turned off) in the transmit mode. Conversely, the transmit path 280 may be deactivated in the receive mode. The activation and deactivation of the transmit path 280 and the receive path 290 may be a function of the impedance matching of the on-chip matching circuitry 230 and the impedances provided by the off-chip matching circuitry 240.

In the transmit mode, the transmit path 280 is active and actively transmitting a transmit signal 202 via the antenna node 250 and the antenna 140. In the transmit mode, the receive path 290 (and, e.g., the LNA 220) is isolated from the antenna node 250 so as not to interfere with transmit operations. In the receive mode, the opposite configuration is provided. The receive path 290 is active, receiving a receive signal 204 via the antenna node 250, while the transmit path (and, e.g., the PA 210) is isolated from the antenna node 250. This type of operation forms a switching arrangement by varying the impedance at the off-chip matching circuitry 240.

In the transmit mode, the PA 210 can receive and amplify the transmit signal 202 to be transmitted by the RF front-end circuit 200 via the antenna 140. The amplified transmit signal 202 can be input to the transmitter on-chip matching circuit 232. The controller 270 can then activate the on-chip matching circuit 232 which can be tuned to provide a matched impedance of the transmit path 280.

The output of the transmitter on-chip matching circuit 232 can be routed to the transmitter off-chip matching circuit 242 via the package 235. The transmitter off-chip matching circuit 242 can be located, for example, on the PCB 50 that contains the chip 10, for example. The transmitter off-chip matching circuit 242 can be tuned to provide high “OFF” impedance for the PA 210 when the transmit path 280 is deactivated and the receive path 290 is activated (e.g., turned on) for receive operations. Thus, during the receive mode, the transmitter off-chip matching circuit 242 can present a high impedance at the antenna node 250. This high impedance can isolate the transmit path 280 from the antenna node 250. This arrangement can further eliminate or reduce the need for an external TRSW 100.

As used herein, “high impedance” can refer to impedances that appear as a high impedance relative to a traditional design. In other words, the high impedance can effectively block or reduce a signal in one of the transmit path 280 and the receive path 290 to allow the other path to operate without interference. The high impedance can “switch off” or deactivate one of the paths. In some examples, such a “high impedance” can appear as an open circuit to one of the transmit path 280 and the receive path 290. In other examples, high impedance can be a resistance of 200 ohms (Ω) or more. In other examples, high impedance can comprise 300Ω, 300Ω, 500Ω, or 600Ω depending on the application of the matching circuits and applications and frequency bands. In some embodiments, the high impedance can be on the order of mega ohms (MΩ).

In the receive mode, an RF receive signal 204 can be received at the antenna 140 and propagate to the receive path 290 via the antenna node 250. The receiver off-chip matching circuit 244 can be located on the PCB to which the chip 10 is attached. The receiver off-chip matching circuit 244 can selectively provide high “OFF” impedance to the LNA 220. For example, when the receive path 290 is deactivated and the transmit path 280 is activated. During the receive mode, the output of the receiver off-chip matching circuit 244 can be routed to the receiver on-chip matching circuit 234 via the package 235. The receiver on-chip matching circuit 234 can provide varying levels of input impedance (e.g., for impedance matching) for the LNA 220. During the transmit mode, the receiver off-chip matching circuit 244 can provide high impedance at the antenna node 250 to provide isolation of the receive path 290. This can eliminate or reduce the need for an external TRSW.

FIG. 3 is a circuit diagram of an embodiment of the RF front-end circuit of FIG. 2. An RF front-end circuit (circuit) 300 can have various matching circuits/circuitry configured on-chip and/or off-chip. In some embodiments, the off-chip matching circuitry can be located on the PCB 50 containing the circuit 300, or other given system (e.g., the chip 10). A transmit path 302 and a receive path 304 can be joined together on the PCB 50, at an antenna node 350, similar to the antenna node 250, for example. The antenna node 350 can directly couple the transmit path 302 and the receive path 304 without the use of an external TRSW. The RF front-end circuit 300 also includes a controller 370 operable to control on-chip matching circuits 322, 324. In some implementations, the controller 370 can provide a control signal to the on-chip matching circuits 322, 324 to adjust impedance. The circuit 300 can operate in a transmit mode and a receive mode, similar to the circuit 200. In the transmit mode, the transmit path 302 is activated and the receive path 304 is deactivated. In the receive mode, the receive path 304 is activated and the transmit path 302 is deactivated. The activation and deactivation of the transmit path 302 and the receive path 304 can be accomplished through switching within the on-chip matching circuits 322, 324 and impedance matching within the off-chip matching circuit(s).

The transmit path 302 can have a PA 310. The PA 310 can amplify a differential transmit signal 360 (e.g., a differential input) received from a transmitter front-end circuit (not shown), for example. The PA 310 can output, for example, a differential output signal at a pair of outputs 311 (shown as outputs 311a, 311b). In some embodiments, the PA 310 can alternatively have a single output. The transmitter on-chip matching circuit 322 can be used to provide an optimal load impedance that can provide a high saturated output power (P_{SAT}) point for the PA 310.

The transmitter on-chip matching circuit 322 can have at least a transistor switch M₁ and a switched capacitor C₁. In some other embodiments, (e.g., for differential PA configurations) symmetric switched capacitors (e.g., C₁) can be implemented. For example, another capacitor similar to C₁ can be implemented opposite the transistor switch M₁. Thus, the configuration of the circuit 300 shown can further have C₁-M₁-C₁ in series across the differential outputs of the PA 310. In another embodiment, a single capacitor C₁ and transistor switch M₁ similar to that shown can be used, coupled between a single-ended PA output (e.g., a single, non-differential output) and ground. Thus, the transmitter on-chip matching circuit 322 can be coupled between two differential output terminals of a differential power amplifier (e.g., the PA 310) or a single output terminal of a single-ended power amplifier and ground.

The transistor switch M₁ can be a field effect transistor (FET), for example. During the transmit mode, the transistor switch M₁ can be activated on so that the switched capacitor C₁ couples across the differential outputs of the PA 310 to provide an optimal load impedance at the outputs of the PA 310. The optimal load impedance can result in a high saturated output power (P_{SAT}) point for the PA 310. The controller 370 can be coupled to the transmitter on-chip matching circuit 322, similar to the controller 270. The controller 370 can provide a control signal to control the activation and deactivation of the transistor switch M₁. For example, the control signal can be received at the gate of the transistor switch M₁ to open or close the circuit from the PA 310. For example, the switch M₁ is switched ON when in the transmit mode, that is, when the transmit path 302 is active.

The output of the transmitter on-chip matching circuit 322 can be coupled to the transmitter off-chip matching circuit 342 via a package 330 and a balun T₁. The package 330 can be similar to the package 235 (FIG. 2). The balun T1 can be a transformer configured to suppress a common mode noise component of the differential signal provided at the outputs 311.

In some embodiments, the transmitter off-chip matching circuit 342 can be located on the PCB 50, but not within the chip 10, for example. The transmitter off-chip matching circuit 342 can be configured as an LC matching circuit with inductor L₁ and capacitor C₂. The LC matching circuit of the transmitter off-chip matching circuit 342 can provide high OFF impedance of the PA 310 when the transmit path 302 is deactivated (and M₁ is switched off) and the receive path 304 is activated in the receive mode. For example, the controller 370 can switch the transistor switch M₁ to “OFF,” providing a high impedance at the antenna node 350. The high impedance at the antenna node 350 can thus isolate the transmit path 302. The transmitter on-chip matching circuit 322 and the transmitter off-chip matching circuit 342 can provide both an optimal load impedance to the PA 310 and high OFF impedance from the PA 310 at antenna node 350 that can switch between transmit mode and receive mode. This can eliminate the need for an external TRSW at the antenna 140. The matched impedance can be provided by tuning the components of the transmitter on-chip matching circuitry 322 and the transmitter off-chip matching circuit 342.

In the receive mode, the RF receive signal is received from the antenna (e.g., the antenna 140) at the antenna node 350. The receive path 304 can have receiver off-chip matching circuits 344, 346a, 346b. The receiver off-chip matching circuits 344, 346a, 346b can be disposed on the PCB 50, similar to above. The receiver off-chip matching circuits 344, 346a, 346b can be configured to provide high OFF impedance from the LNA 312 when the receive path 304 is deactivated, or turned off. This can allow the transmit path 302 to operate without interference from the receive path 304. The receiver off-chip matching circuits 344, 346a, 346b can be configured with a plurality of inductors L₂, L₃, L₄, L₅ and a plurality of capacitors C₃, C₄, C₅. The arrangement of the inductors and capacitors can provide high OFF impedance from the LNA 312 when the transmit path 302 is activated (e.g., M₁ is closed) and the receive path 304 is deactivated (e.g., switches S₁ and S₂ are opened).

The matching circuit 346a, coupled to antenna node 350, can have the inductor L₃ and the capacitor C₃ configured as an LC circuit. The capacitor C₃ can be coupled in series between the antenna node 350 and a node 348. The inductor L₃ can be coupled between the node 348 to ground or a ground terminal.

The output of the matching circuit 346a can be coupled to the node 348 to split and form a first input 380 and a second input 382 (e.g., a differential input) to the LNA 312 following the receiver off-chip matching circuits 346b, 344. The matching circuit 346b can have the inductors L₄ and L₅ and the capacitors C₄ and C₅ to provide high OFF impedance from the LNA 312 in the transmit mode when the LNA 362 is OFF and both switches S₁ and S₂ are switched ON by closing the switches (i.e., activated).

The inductor L₂ of the matching circuit 344 can be coupled across the differential inputs (e.g., the first input 380 and the second input 382) to improve the single-ended to differential conversion. The differential signals (the first input 380 and the second input 382) can then be coupled to the LNA 312 via a package 332. In some embodiments, the package 330 and the package 332 can be portions of a single package (e.g., the package 235 of FIG. 2) encapsulating the chip 10.

In some embodiments, the inductors L₂ and L₃ of the matching circuits 344, 346 can be replaced with other electrical elements such as capacitors, depending on tuning characteristics, desired frequency response, and range of desired impedances, for example. The use of an inductor or a capacitor at, for example, L₂, may depend on the LNA 312 ON impedance in the receive mode. As another example, the use of an inductor or a capacitor at L₃ may depend on LNA OFF impedance for the transmit more.] It is also possible to eliminate the inductors L₂ and L₃ altogether given certain circumstances for similar reasons.

The receiver on-chip matching circuit 324 can have a pair of switches S₁, S₂, (a first switch S₁ and a second switch S₂) coupled to the first input 380 and the second input 382, respectively. The first switch S₁ and the second switch S₂ can be coupled to each line of the differential input signal lines, switchably coupling the differential input lines of the LNA 312 to ground. The first switch S₁ and the second switch S₂ can be closed when the receive path 304 is deactivated, coupling the differential inputs to ground. This can provide high OFF impedance to the LNA 312 isolating the LNA 312 from the antenna node 350. Hence, receiver on-chip matching circuit 324 may also be referred to as a receiver on-chip isolation circuit.

The controller 370 can be coupled to the first switch S₁ and the second switch S₂ and provide a control signal to activate and deactivate (e.g., close and open) the first switch S₁ and the second switch S₂.

Accordingly, the LNA input resonant matching circuits 324, 344, 346 can provide both optimal ON impedance (e.g., 50-ohm LNA input impedance) and high OFF impedance for the LNA 312 to isolate the receive path 304 from the antenna node 350. This can effectively switch the receive path 304 and the LNA 312 out of the circuit 300 during the transmit mode and provide a switching function at the antenna node 350 without an external TRSW.

In another embodiment, the LNA 312 can be configured to receive only the first input 380 (e.g., a single input). In such a configuration, the receive path 304 can be configured with only the matching circuit 346a, eliminating the matching circuits 344, 346b, and the switch S₂ of the receiver on-chip matching circuit 324.

In some examples, the high impedance matching can be achieved by tuning the on-chip matching circuitry 230 and the off-chip matching circuitry 240 together. This, in addition to the switching or programmable circuits (e.g., the controller 370, M₁, S₁, S₂) that comprise the on-chip matching circuitry 230 (e.g., FIG. 2) can control impedance according to transmit or receive modes. As shown in FIG. 3, in transmit mode, the switches of S₁ and S₂ of the receiver on-chip matching circuit 324 can be closed creating a high impedance of at the receive path 304 at antenna node 350. Conversely, while in the receive mode, the transistor switch M₁ is OFF, presenting high impedance for the transmit path 302 at the antenna node 350.

Those of skill will appreciate that the various illustrative blocks and modules described in connection with the embodiments disclosed herein can be implemented in various forms. Some blocks and modules have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the disclosure. In addition, the grouping of functions within a module, block, or step is for ease of description. Specific functions or steps can be moved from one module or block without departing from the disclosure.

The above description of the disclosed embodiments is provided to enable any person skilled in the art to make or use the disclosure. Various modifications to these embodiments will be readily apparent to those skilled in the art, and the generic principles described herein can be applied to other embodiments without departing from the spirit or scope of the disclosure. Thus, it is to be understood that the description and drawings presented herein represent presently preferred embodiments of the disclosure and are therefore representative of the subject matter which is broadly contemplated by the present disclosure. It is further understood that the scope of the present disclosure fully encompasses other embodiments that may become obvious to those skilled in the art and that the scope of the present disclosure is accordingly limited by nothing other than the appended claims.

What is claimed is:

1. A resonant matching circuit being at least partially disposed on a chip, the resonant matching circuit comprising:
a transmitter off-chip matching circuit disposed outside the chip and coupled to an antenna node;
a transmitter on-chip matching circuit disposed within the chip and coupled to the transmitter off-chip matching circuit, the transmitter on-chip matching circuit having a transistor and a first capacitor coupled between a first output and a second output of a power amplifier;
a receiver off-chip matching circuit coupled to the antenna node; and
a receiver on-chip matching circuit disposed within the chip and coupled to the receiver off-chip matching circuit, the receiver on-chip matching circuit having
a first switch connected between a first input of a low noise amplifier and ground, and
a second switch connected between a second input of the low noise amplifier and ground.

2. The resonant matching circuit of claim 1, further comprising a controller configured to generate a control signal sent to a gate terminal of the transistor.

3. The resonant matching circuit of claim 1, further comprising a controller configured to generate a control signal to selectively activate and deactivate the first switch and the second switch.

4. The resonant matching circuit of claim 1, wherein the transmitter off-chip matching circuit comprises:
a second capacitor coupled to the antenna node; and
a first inductor coupled to the second capacitor and ground,
wherein the second capacitor and the first inductor are tuned to provide matched impedance when the transmitter on-chip matching circuit is activated.

5. The resonant matching circuit of claim 4, wherein the second capacitor is coupled to the first output and the second output via a package of the chip.

6. The resonant matching circuit of claim 1, wherein the receiver off-chip matching circuit comprises a second inductor coupled to the first input and the second input of the low noise amplifier.

7. The resonant matching circuit of claim 6, wherein the second inductor couples to the first input and the second input via a package of the chip.

8. The resonant matching circuit of claim 1, wherein the receiver off-chip matching circuit comprises:
a third capacitor coupled to the antenna node; and
a third inductor coupled to the third capacitor and ground.

9. A resonant matching circuit coupling a transmit path and a receive path of a transceiver to at least one antenna, the resonant matching circuit comprising:
off-chip matching circuitry disposed outside a chip, the off-chip matching circuitry comprising first transmit path matching circuitry and first receive path matching circuitry;
on-chip matching circuitry disposed within the chip and coupled to the off-chip matching circuitry and comprising second transmit path matching circuitry and second receive path matching circuitry, the on-chip matching circuitry, in combination with the off-chip matching circuity, configured to;
in a transmit mode of the resonant matching circuit, selectively activate a plurality of switches of the on-chip matching circuitry to:
provide a matched impedance in the transmit path including the first and second transmit path matching circuitry, and
provide a high impedance in a receive path including the first and second receive path matching circuitry; and
in a receive mode of the resonant matching circuit, selectively activate the plurality of switches of the on-chip matching circuitry to:
provide a matched impedance in the receive path; and
provide a high impedance in the transmit path.

10. The resonant matching circuit of claim 9, further comprising a power amplifier, disposed in the chip, coupled to the second transmit path matching circuitry, the second transmit path matching circuitry and the first transmit path matching circuitry being configured to:
provide a matched impedance between the power amplifier and an antenna node in the transmit mode; and
isolate the power amplifier from the antenna node during the receive mode.

11. The resonant matching circuit of claim 10, wherein providing the high impedance and the matched impedance to the antenna node is performed without a transmit/receive switch (TRSW) being located between the resonant matching circuitry and the antenna node.

12. The resonant matching circuit of claim 10, wherein the second transmit matching circuitry comprises:
a first capacitor coupled to a first output of the power amplifier; and
a switched transistor coupled to the first capacitor and a second output of the power amplifier, wherein a gate of the switched transistor is coupled to a controller.

13. The resonant matching circuit of claim 12, wherein the first transmit matching circuitry comprises:
a second capacitor coupled to the first output of the power amplifier; and
a first inductor coupled to the second capacitor and ground.

14. The resonant matching circuit of claim 12, wherein the switched transistor is configured to be enabled during the transmit mode and disabled during the receive mode.

15. The resonant matching circuit of claim 11, wherein:
the off-chip matching circuitry comprises a receiver off-chip matching circuit in the receive path;
the on-chip matching circuitry comprises a receiver on-chip matching circuit in the receive path.

16. The resonant matching circuit of claim 15, further comprising a low noise amplifier coupled to the receiver on-chip matching circuit, the receiver on-chip matching circuit and the receiver off-chip matching circuit being configured to:
provide a matched impedance between the low noise amplifier and an antenna node in the receive mode; and
isolate the low noise amplifier from the antenna node during the transmit mode.

17. The resonant matching circuit of claim 16, wherein the receiver on-chip matching circuit comprises:
a first switch coupled between a first input of the low noise amplifier and ground; and
a second switch coupled between a second input of the low noise amplifier and ground.

18. The resonant matching circuit of claim 17, wherein the first switch and the second switch are configured to receive activation and deactivation commands from a controller to close during the transmit mode and open during the receive mode.

19. The resonant matching circuit of claim 17, wherein the receiver off-chip matching circuit comprises:
a second inductor coupled between the first input and the second input;
a capacitor coupled to the antenna node; and
a third inductor coupled to the capacitor and ground.

20. An apparatus for matching impedance in a circuit having a transmit path and a receive path coupling a transceiver to at least one antenna, the apparatus being at least partially deployed on a chip and comprising:
a first means for impedance matching for matching impedance between the transceiver and the at least one antenna, the first means for impedance matching disposed within the chip;
a means for controlling the first means for impedance matching, the means for controlling being configured to
in a transmit mode, cause the first means for impedance matching to provide a matched impedance in the transmit path, and
in a receive mode, cause the first means for impedance matching to provide a matched impedance in the receive path;
a second means for impedance matching for providing high impedance in the receive path in the transmit mode and for providing high impedance in the transmit path in the receive mode, the second means for impedance matching disposed outside the chip and coupled to the first means for impedance matching; and
a means for coupling the transmit path and the receive path to the at least one antenna.

21. The apparatus of claim 20, wherein
the second means for impedance matching comprises a transmitter off-chip matching means in the transmit path and a receiver off-chip means in the receive path, and
the first means for impedance matching comprises a transmitter on-chip matching means in the transmit path and a receiver on-chip means in the receive path.

22. The apparatus of claim 21, further comprising a first means for amplifying a transmit signal coupled to the transmitter on-chip matching means, the transmitter on-chip matching means and the transmitter off-chip matching means being configured to:
provide a matched impedance between the first means for amplifying and the means for coupling in the transmit mode; and
isolate the first means for amplifying from the means for coupling in the receive mode.

23. The apparatus of claim 21, wherein:
the second means for impedance matching comprises a receiver off-chip matching means in the receive path;
the first means for impedance matching comprises a receiver on-chip matching means in the receive path.

24. The apparatus of claim 23, further comprising a second means for amplifying a receive signal coupled to the receiver on-chip matching means, the receiver on-chip matching means and the receiver off-chip matching means being configured to:
provide a matched impedance between the second means for amplifying and the means for coupling in the receive mode; and
isolate the second means for amplifying from the means for coupling in the transmit mode.

25. A resonant matching circuit for matching impedance in a circuit having a transmit path and a receive path coupling a transceiver to at least one antenna, the apparatus being at least partially deployed on an integrated circuit (IC) and comprising:
on-chip matching circuitry disposed within the IC and coupled to at least first and second radio frequency (RF) amplifiers, the on-chip matching circuitry having
a transmitter on-chip matching circuit in the transmit path, and
a receiver on-chip isolation circuit in the receive path;
off-chip matching circuitry disposed outside the IC and coupling the on-chip matching circuitry to an antenna node for coupling to the at least one antenna, the off-chip matching circuitry having
a transmitter off-chip matching circuit in the transmit path, and
a receiver off-chip matching circuit in the receive path;
a controller coupled to the on-chip matching circuitry and configured to
activate the transmitter on-chip matching circuit to provide, in combination with the transmitter off-chip matching circuitry, matching between the first RF amplifier and the antenna node in a transmit mode, and
deactivate the receiver on-chip isolation circuit to provide in combination with the receiver off-chip matching circuitry, matching between the second RF amplifier and the antenna node in a receive mode.

26. The resonant matching circuit of claim 25, wherein:
the transmitter off-chip matching circuit, in combination with the transmitter on-chip matching circuitry is tuned to isolate the first RF amplifier from the antenna node in the receive mode; and
the receiver off-chip matching circuit, in combination with the receiver on-chip isolation circuit, is tuned to isolate the second RF amplifier from the antenna node in the transmit mode.

27. The resonant matching circuit of claim 26, wherein the isolation comprises providing high impedance to isolate the first or the second RF amplifier from the antenna node.

28. The resonant matching circuit of claim 25, wherein the controller is further configured to:
deactivate the transmitter on-chip matching circuit to provide, in combination with the transmitter off-chip matching circuitry, isolation between the first RF amplifier and the antenna node in the receive mode, and
activate the receiver on-chip isolation circuit to provide in combination with the receiver off-chip matching circuitry, isolation between the second RF amplifier and the antenna node in the transmit mode.

29. The resonant matching circuit of claim 27 wherein high impedance comprises 200 ohms or higher.

30. The resonant matching circuit of claim 25 wherein the off-chip matching circuitry is disposed on a printed circuit board (PCB) containing the IC.
